(19) United States
(12) Patent Application Publication
(10) Pub. No.: US 2024/0256852 A1
(43) Pub. Date: Aug. 1, 2024

(54) ENTITY STANDARDIZATION FOR APPLICATION MODERNIZATION

(71) Applicant: INTERNATIONAL BUSINESS MACHINES CORPORATION, Armonk, NY (US)

(72) Inventors: Jiaqing Yuan, Raleigh, NC (US); Michele Merler, New York, NY (US); Mihir Choudhury, Jersey City, NJ (US); Venkata Nagaraju Pavuluri, New Rochelle, NY (US); Maja Vukovic, New York, NY (US)

(21) Appl. No.: 18/160,301

(22) Filed: Jan. 26, 2023

(51) Int. Cl. G06N 3/08; G06N 5/022

(52) U.S. Cl. CPC G06N 3/08; G06N 5/022

(57) ABSTRACT

Standardizing a mention of an application component in a free-form text describing the technology stack of the application includes extracting the mention and encoding the mention with an embedding space encoder. The encoding creates an encoded representation of the mention in a multi-dimensional embedding space. The embedding space encoder implements a machine learning model trained using contrastive learning. The encoded representation of the mention is mapped to an encoded representation of an entity in the multi-dimensional embedding space, the entity extracted from a knowledge base of computer components. The entity whose encoded representation maps to the encoded representation of the mention can be output responsive to the mapping.

### STATEMENT REGARDING PRIOR DISCLOSURE BY THE INVENTORS

The following disclosure is submitted under 35 U.S.C. 102(b)(1)(A):
https://github.com/konveyor/tackle-container-advisor. The referenced code and comments were made publicly available by the inventors on Jul. 25, 2022.

### BACKGROUND

This disclosure relates to computer applications, and, more particularly, to modernizing legacy applications.

Application modernization is the updating of a legacy application. Modernization is often necessary if an application is to run on a newer architecture or hardware platform or utilize a newer software library, for example. Modernizing a legacy application for executing in a cloud-based environment, for example, can involve migrating and containerizing the application. One of the most important aspects of any modernization is an accurate assessment of the technical components of the applications. Typically, such information is obtained from the legacy application's technology stack. The technology stack information needed to modernize an application efficiently and successfully, however, is usually available only in free-form textual descriptions. The automatic extraction of such information from a textual description of a technology stack is a non-trivial task.

A “mention” of a specific application component—that is, a reference to a component in the description of the technology stack—can take different forms. The mention may be a word, phrase, acronym, symbol or the like. The same application component may be mentioned in different ways in different technology stacks. This poses a significant challenge to entity standardization, which aims to map various technical mentions to entities in a knowledge base. The knowledge base entities are words, phrases, acronyms, symbols, or the like, that are widely recognized by working professionals as referring to specific application components. Entities drawn from a knowledge base are thus standard references to application components. A mention extracted from a textual description, however, may take form—name, acronym, symbols, or the like—that differs from the name, acronym, or symbols that are widely recognized by computer professionals. This poses a significant challenge to mapping the mention to the correct entity, which is the aim of standardization. Another challenge is how to efficiently perform entity standardization at scale, given that an enterprise or other entity seeking to modernize its software may have thousands of applications that the entity wishes to modernize or migrate to the cloud.

Existing tools do not fully enable machine-based standardization of mentions. Some tools rely on the term frequency-inverse document frequency (TF-IDF) model to encode entities and mentions. TF-IDF encodings rely on token overlap in the search for entities most similar to each mention and fail to capture syntactic and semantic variations. The token vocabulary of the particular TF-IDF model, moreover, is determined by the dataset used to train the model, which necessitates re-training the model with each update of the relevant knowledge base.

Tools that utilize a deep neural network likewise do not satisfactorily enable machine-based standardization of mentions. Such tools identify records that refer to the same entity, where the records are constructed in accordance with a specific schema of attributes. This, however, does not apply to the entity standardization problem because there are no attributes associated with entity mentions. Entity disambiguation tools identify entity mentions in raw text with context and link them to the entities in a knowledge base, but in the context of entity standardization, mentions typically have no context. Moreover, entities in the knowledge base typically do not have rich information, which again makes them ill-suited for machine-based standardization of mentions.

### SUMMARY

In one or more embodiments, a method includes extracting a mention of a computer application component from a free-form text. The free-form text is a textual description of a technology stack of the computer application. The method includes encoding the mention with an embedding space encoder. The encoding creates an encoded representation of the mention in a multi-dimensional embedding space. The embedding space encoder implements a machine learning model trained using contrastive learning. The method includes mapping the encoded representation of the mention to an encoded representation of an entity in the multi-dimensional embedding space. The entity is extracted from a knowledge base of computer components. The method includes outputting the entity whose encoded representation maps to the encoded representation of the mention.

Among the advantages of the method is an efficient and effective mapping of mentions that typically lack a surrounding context and usually have no attributes or discernable relationship with the knowledge base entities. The method overcomes these obstacles by the embedding space encoder's implementing the learning model using contrastive learning.

In one aspect, the machine learning model implemented by the embedding space encoder is a Siamese neural network.

In another aspect, a backbone of the machine learning model implemented by the embedding space encoder is a context-sensitive, per-trained transformer language model. For example, in certain embodiments the machine learning model is configured with a Bidirectional Encoder Representations from Transformers (BERT) backbone.

In another aspect, the embedding space encoder is trained using a hybrid batch-all and batch-hard online triplet loss mining.

In another aspect, the mapping is performed by determining a vectorial distance between the encoded representation of the mention and the encoded representation of the entity in the knowledge base. The vectorial distance, in some embodiments, is determined based on a cosine similarity between the encoded representation of the mention and the encoded representation of the entity in the knowledge base. In other embodiments, the vectorial distance is a Euclidean distance. Other measures of vectorial distance can be determined in still other embodiments.

In one or more embodiments, a method includes generating a stand-alone encoder that implements a contrastive learning model trained using a hybrid batch-all and batch-hard online triplet mining. The method includes encoding, by the stand-alone encoder, a plurality of entities drawn from a knowledge base to create a unique encoded representation of each of the plurality of entities. An advantage of the stand-alone encoder is that it enables a framework that decouples the pairwise mention-entity comparisons during the training process and the mappings performed at inference time. Accordingly, standard entity names drawn from a knowledge base can be pre-encoded and, optionally, hashed prior to performing inferences (mapping mentions to entities). At inference time, the running time can be linear in accordance with the number of mentions for which inferences are sought. A further advantage, therefore, is that efficient, large-scale inferences can be performed.

In one or more embodiments, a method of creating an encoder includes generating a plurality of triplet examples to train a contrastive learning model implemented by the encoder. The method includes iteratively adjusting parameters of the contrastive learning model during an initial sequence of training epochs using batch-all mining with the triplet examples. The method includes further adjusting the parameters of the contrastive learning model during a subsequent sequence of training epochs using batch-hard mining as the parameters converge to a final set of values. Among the advantages of the method is that, initially, with parameters randomly initialized, batch-all mining is necessary. In later epochs, however, batch-hard mining allows the parameters to converge to optimal, or nearly optimal, values more rapidly thereby increasing the overall efficiency of the machine learning.

In one or more embodiments, a system includes a processor configured to initiate executable operations as described within this disclosure.

In one or more embodiments, a computer program product includes one or more computer readable storage mediums having program code stored thereon. The program code is executable by a processor to initiate executable operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing an application entity standardization (AES) framework.

FIG. 2 illustrates an example architecture for the executable AES framework illustrated in FIG. 1.

FIG. 3 illustrates an example method of operation of the AES framework illustrated in FIGS. 1 and 2.

FIG. 4 schematically illustrates aspects of training an example embedding space encoder using contrastive machine learning.

FIG. 5 schematically illustrates training the embedding space encoder in FIG. 4 using example similar and dissimilar entities.

FIG. 6 schematically illustrates certain operative aspects of entity standardization performed by the AES framework illustrated in FIGS. 1 and 2.

FIG. 7 schematically illustrates an example standardization of mentions performed by the AES framework illustrated in FIGS. 1 and 2.

### DETAILED DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to computer application, and, more particularly, to modernizing legacy applications. Entity standardization is a necessary part of modernizing a legacy application, but machine-based extraction and standardization of mentions poses several challenges. Entity mentions in a free-form textual description, for example, are often in the form of words, acronyms, numbers, symbols, and aliases. Many such forms may be unconventional—that is, words, acronyms, numbers, symbols, and aliases not typically used nor widely recognized though referring to a known application component. Mentions may be presented in a technology stack. A technology stack describes the combination of technologies that are used to build and run an application or project. Sometimes called a “solutions stack,” a technology stack typically consists of programming languages, frameworks, a database, front-end tools, back-end tools, and applications connected via APIs. It is not at all uncommon that a mention of a component is presented in a technology stack using atypical or unusual terms (e.g., names, words, symbols) or punctuations or even misspellings. A significant obstacle to natural language processing of textual mentions is a lack of context surrounding the mentions and the absence of attributes or relationships among entities contained in a knowledge base. An obstacle to deep learning-based approaches is a lack of large-sized sets of training examples, especially for specific technical domains.

In accordance with the inventive arrangements described herein, methods, systems, and computer program products are provided that are capable of extracting and standardizing mentions of components within a free-form textual description of a computer application's technology stack. The application components mentioned in a technical stack description encompass architectures, software libraries, hardware platforms, and other entities specific to the application. The inventive arrangements disclosed herein automate the extracting and standardizing mentions of application components within a free-form textual description of a technology stack. As used herein, “standardize” means an automated, machine-based action that maps a mention extracted from a technology stack to one of a plurality of entities in a knowledge base. The knowledge base entities are terms (e.g., names, acronyms, symbols) widely recognized among working professionals as indicating specific components (including both software and hardware elements) used to implement a computer application.

The inventive arrangements, in one aspect, utilize contrastive learning to train an embedding space encoder. The embedding space encoder is then capable of encoding mentions in a multi-dimensional embedding space. The mentions are extracted from text for encoding through preprocessing the text. The text can be a free-form textual description of an application's technical stack. The embedding space encoder can encode each extracted mention in a high-dimensional embedding space. The encoded representation of a mention within the embedding space can be compared with similarly encoded entities drawn from a knowledge base of application components.

In another aspect, standardization of a mention in accordance with the inventive arrangements is made based on a distance measurement of the encoded representations within the multi-dimensional embedding space. The multi-dimensional embedding space comprises a vector space. Accordingly, a mention can be standardized by matching, based on the distance measurement, the mention to an entity drawn from the knowledge base. The distance measurement is a vectorial distance between the encoded representations of the mention and an entity. In certain embodiments, the distance measurement is a cosine similarity between the mention and entities encoded as vectors. In other embodiments, the distance measurement is the Euclidean distance between the vectors. In still other embodiments, other vectorial distance measurements can be used for determining similarity between the encoded representations (vectors) of the mention and encoded representations (vectors) of the entities within the embedding space.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

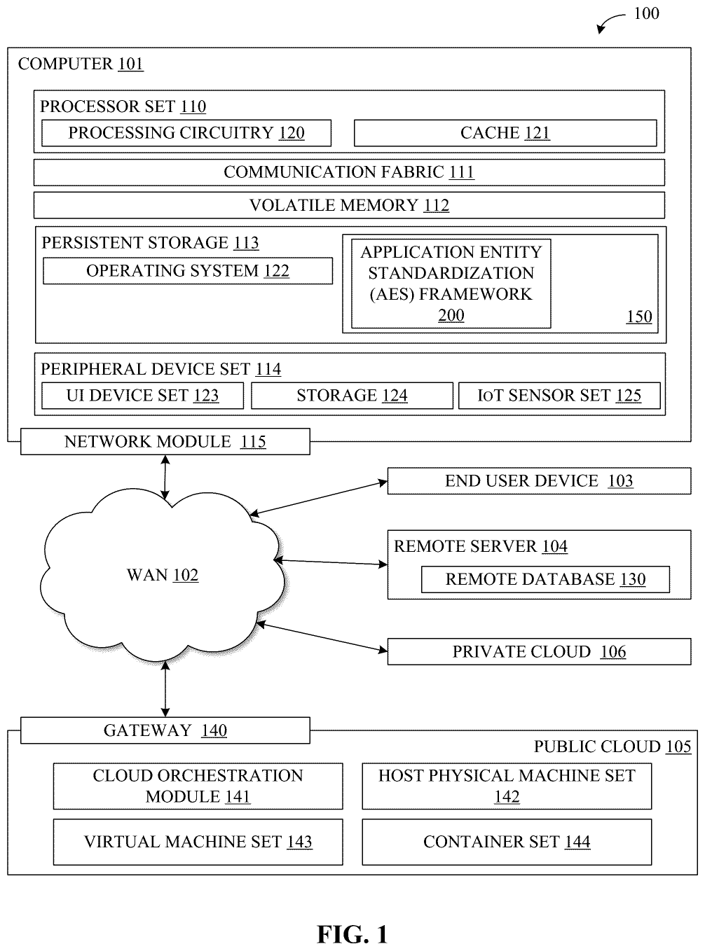

Referring to FIG. 1, computing environment 100 contains an example of an environment for the execution of at least some of the computer code in block 150 involved in performing the inventive methods, such as application entity standardization (AES) framework 200 implemented as executable program code or instructions. AES framework 200 is capable of extracting and standardizing mentions of application components within a free-form textual description of the application's technology stack. Using an embedding space encoder trained using contrastive learning, AES framework 200 embeds mentions extracted from text and entities drawn from a knowledge base in a multi-dimensional embedding space. The text from which the mentions are extracted can be a free-form textual description of an application's technology stack. The knowledge base can comprise entities corresponding to different application components. A mention is standardized based on a similarity between the encoded representations of the mention and entities within the embedding space. The encoded embeddings are vectors, and the embedding space is a vector space. Thus, the similarity can be determined by finding the entity whose embedded encoding is closest to that of the mention. The measure of similarity can be a cosine similarity, Euclidean distance, or other such measurement of distances between the encoded embeddings within the embedding space.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and AES framework 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

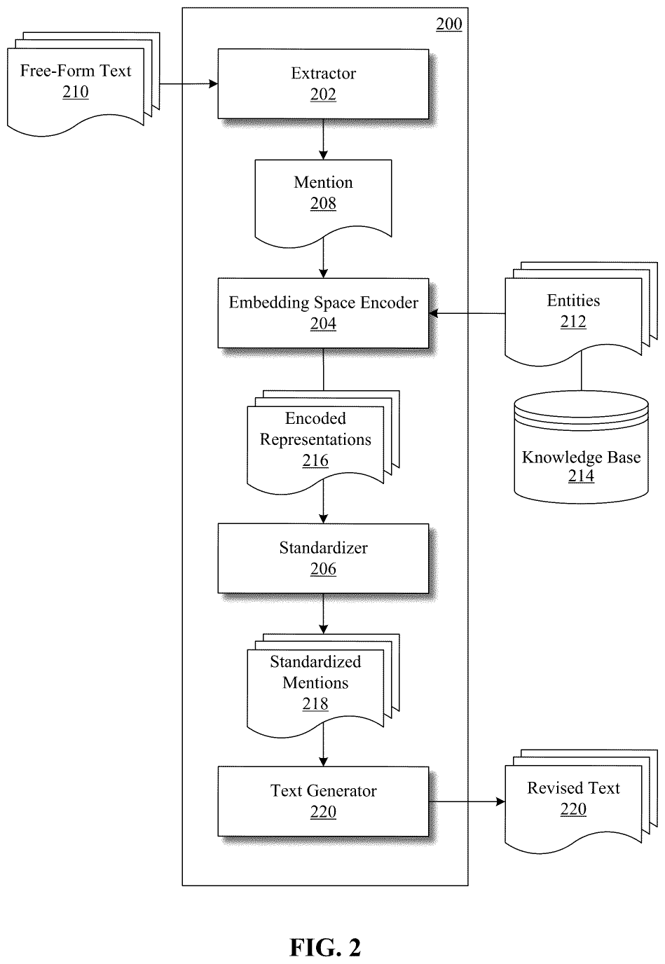

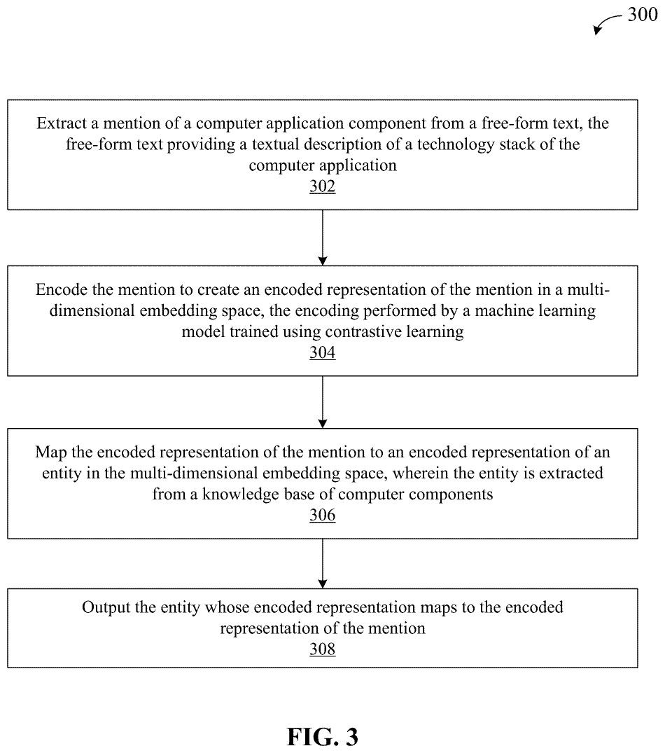

FIG. 2 illustrates an example architecture for the executable AES framework 200 of FIG. 1. In the example of FIG. 2, AES framework 200 illustratively includes extractor 202, embedding space encoder 204, and standardizer 206. Optionally, AES framework 200 also includes text generator 220. FIG. 3 illustrates an example method 300 of operation of the AES framework 200 of FIGS. 1 and 2.

Referring to FIGS. 2 and 3 collectively, in block 302, extractor 202 extracts mention 208 from free-form text 210. Free-form text 210 is a textual description of a technology stack of a specific computer application. Mention 208 is a textual mention of, or reference to, a software or hardware component as it appears in free-form text 210 that describes the technology stack of a computer application. In certain embodiments, extractor 202 implements parts-of-speech tagging using natural language processing (NLP) to identify within free-form text 210 names, nouns, or noun phrases that may be a mention for extraction from free-form text 210. In some embodiments, extractor 202 implements a delimiter-based, string-splitting technique using a set of known delimiters, such as a period (“.”), comma (“,”), colon (“:”), semi-colon (“;”), or other punctuation mark or symbol, to split strings into substrings that extractor 202 then passes directly to embedding space encoder 204. In other embodiments, extractor 202 identifies mentions for extracting by performing a word search of free-form text 210. The word search determines whether one or more characters, words, or terms in free-form text 210 matches a character, word, word stem, or term comprising one of entities 212 listed and organized by category in knowledge base 214.

In block 304, embedding space encoder 204 encodes mention 208. The encoding creates an encoded representation of mention 208 in a multi-dimensional embedding space. The multi-dimensional embedding space can comprise a high-dimensional vector space in which encoded representations correspond to vectors within the embedding space having certain properties (e.g., closure under addition and scalar multiplication). These properties are leveraged by standardizer 206, as described in greater detail below, for mapping mention 208 to one of entities 212, which are standard terms for components of an application. The mapping maps mention 208 to the entity—a widely recognized term drawn from knowledge base 214—that corresponds to the computer component to which mention 208 refers, albeit perhaps in an unfamiliar or less conventional form.

Embedding space encoder 204 also encodes entities 212, the standard terms or identifiers of computer components that appear in knowledge base 214. Entities 212 can take various forms, including names, abbreviations, acronyms, numbers, symbols, and the like. An entity may be considered a standard identifier of an application component if it is explicitly defined in the relevant computer literature or is known to be widely used by computer professionals. Knowledge base 214 can include a general collection of entities or application-specific entities. Entities 212 are ones that are standard with respect to the software and hardware components of the technology stack described by free-form text 210. In certain embodiments, AES framework 200 can be communicatively coupled with, or integrated in, an online data mining system (not shown). The data mining system is configured to mine a plurality of online databases for textual descriptions of computer application components and compile the textual descriptions in knowledge base 214. Entities extracted from the textual descriptions by extractor 202 are encoded by embedding space encoder 204 in a multi-dimensional embedding space.

Encoded representations 216 include the encoded representation of mention 208 and encoded representations of entities 212.

In block 306, standardizer 206 maps mention 208 to one of entities 212 drawn from knowledge base 214. Standardizer 206 maps mention 208 to the entity that is closest, in a semantical sense, to mention 208. Specifically, standardizer 206 standardizes mention 208 in that it maps mention 208, as encoded, to the encoded representation of a name, an abbreviation, an acronym, a number, or symbol that most likely gives a full and correct identification of the application component to which mention 208 refers. The mapping is performed automatically and without human intervention.

In block 308, standardizer 206 outputs the entity whose encoded representation maps to the encoded representation of mention 208. The entity output at block 308 corresponds to the standardization of mention 208. The entity, accordingly, provides a widely understood reference to the specific application component to which mention 208 refers in free-form text 210 that describes the application's technology stack.

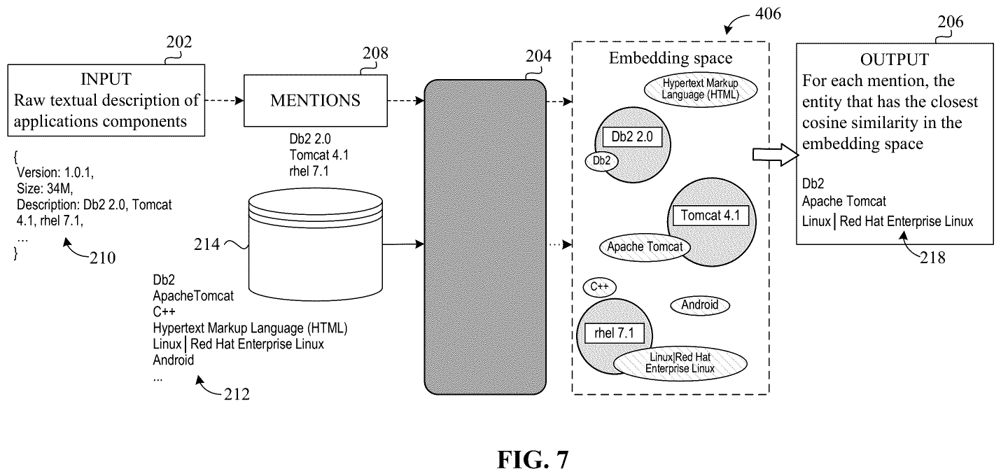

Performing the same process on each mention extracted by extractor 202 from free-form text 210, AES framework 200 is capable of generating standardized mentions 218. Standardized mentions 218 are the one or more entities (from knowledge base 214) to which one or more mentions extracted from free-form text 210 map. Thus, regardless of the form in which each mention appears in free-form text 210, each is mapped by AES framework 200 to an entity that is widely recognized as a correct and accurate identifier of an application component. (See FIG. 7.) Optional text generator 220 can generate and output a list of standardized mentions 218.

Optionally, in certain embodiments, optional text generator 220 generates and outputs revised text 222. Revised text 222 is a revision of the textual description of the technology stack of the computer application. The revision substitutes each mention extracted from free-form text 210 with the entity or entities to which each mention maps. Accordingly, AES framework 200 is capable of automatically, without human intervention, receiving an input of free-form text of a technology stack and outputting a revised text in which each mention is replaced by an entity that is widely recognized by computer professionals. The standardization of mentions facilitates the modernization of legacy computer applications.

In various embodiments, embedding space encoder 204 is implemented as a machine learning model trained using contrastive learning. Contrastive learning is a discriminative learning technique capable of pulling encoded representations of similar entities closer together within an embedding space while pushing dissimilar ones farther apart. Accordingly, with respect to encoded representations (vectors) of entities and mentions in an embedding space (vector space),

$$sim ( f ( x ) , f ( {x}^{+} ) ) ≫ sim ( f ( x ) , f ( {x}^{-} ) ) ,$$

where x is an entity, ƒ(x) is the encoder function that encodes x within the embedding space, and sim is a similarity measure of the “similarity” between x and both similar entities x⁺ and dissimilar entities x⁻. The encoder function ƒ(⋅) can be implemented, for example, as a neural network. Various similarity measures sim(⋅) are described in greater detail below.

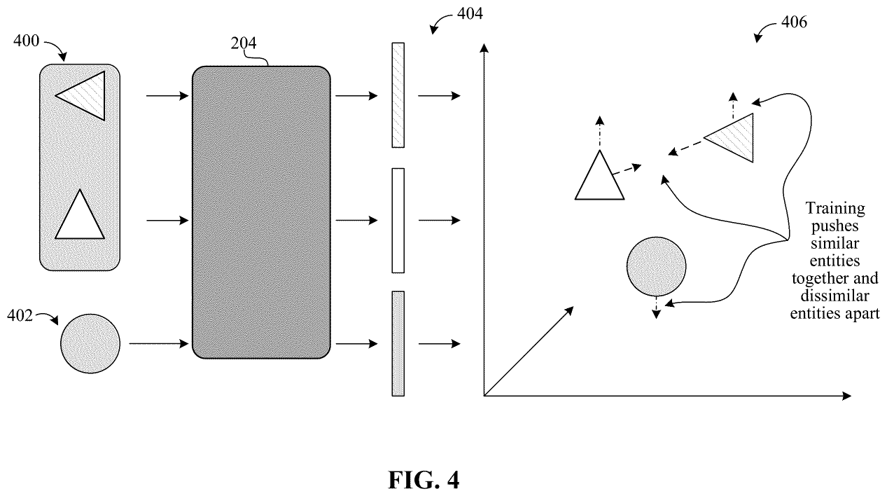

FIG. 4 schematically illustrates aspects of training embedding space encoder 204.

Illustratively, embedding space encoder 204 iteratively learns to encode similar entities 400 and dissimilar entity 402. Embedding space encoder 204 illustratively encodes similar entities 400 and dissimilar entity 402 into encoded representations 404. Trained through contrastive learning, embedding space encoder 204 learns to encode similar entities 400 such that their encoded representations are relatively close together in embedding space 406, while dissimilar entity 402 is relatively far removed from similar entities 400 in embedding space 406.

A contrastive learning algorithm used to train embedding space encoder 204, in certain embodiments, is a supervised learning algorithm. Embedding space encoder 204, in other embodiments, is trained through unsupervised learning with positive training examples generated using data augmentation. Two aspects of contrastive learning are contrastive data creation and contrastive target optimization. Various loss functions can be used for optimization, such as contrastive loss, triplet loss, circle loss, and others.

An example loss function is triplet loss function [symbol] , which is calculated based on sets of triplets {x, x⁺, x⁻} that comprises two sample entities from the same class, x and x⁺, and a third sample entity x⁻ from a different class. The triplet loss function [symbol] is defined as

$$ℒ ≡ Max [ d ( x , {x}^{+} ) - d ( x , {x}^{-} ) + 𝒦 , 0 ] ,$$

where sample entity x is the triplet's “anchor,” x⁺ (the positive sample) belongs to the same class as the anchor, and x⁻ (the negative sample) belongs to a different class. A triplet {x, x⁺, x⁻} represents a unit example used to compute the loss. The margin [symbol] is a hyper-parameter of the machine learning algorithm, which can be either learned or predetermined. The underlying assumption of the triplet loss function [symbol] is that the distance d(x, x⁻) between the anchor and negative sample should be larger than the distance d(x, x⁺) between the anchor and the positive sample by a certain, predetermined margin [symbol] .

Based on the difference in distances d(x, x⁻) and d(x, x⁺), embedding space encoder 204 classifies each triplet into one of three categories:
if d(x, x⁻)−d(x, x⁺)> [symbol] , then the triplet is a soft triple that provides no learning signal to the underlying model implemented by embedding space encoder 204;
if d(x, x⁻)−d(x, x⁺)< [symbol] , then the triplet is a semi-hard triplet that provides some learning signal to the underlying model implemented by embedding space encoder 204; or
if d(x, x⁻)−d(x, x⁺)<0, then the triplet is a hard triplet that provides the maximum learning to the underlying model implemented by embedding space encoder 204.

Among the advantages of training embedding space encoder 204 using contrastive learning is that training can be performed with relatively fewer training samples than typically needed for training many other machine learning models. Moreover, new entities can be introduced without entirely re-training embedding space encoder 204. When a new entity is added to knowledge base 214, the newly added entity is encoded using the current model weights of embedding space encoder 204 without any parameter updating. The newly encoded entity serves as a reference of the newly added entity and is compared against a mention that is passed at inference time. The new entity's encoding can be compared to the encodings of the existing entities. If the new entity's encoding is sufficiently far apart in the embedding space (e.g., vectorial distance larger than a predetermined threshold) from existing encoded representations of entities, there is no need for retraining the weights and updating the parameters of embedding space encoder 204. Optionally, however, when a new entity is added to the knowledge base, another round of machine learning can be performed, and the weights of the model of embedding space encoder 204 can be updated accordingly.

In certain embodiments, the machine learning architecture of embedding space encoder 204 is that of a Siamese neural network. Implemented as a Siamese neural network, embedding space encoder 204 can comprise two or more identical sub-neural networks that have the same architecture and model configuration, and that use the same parameters (weights). Moreover, iterative refining of the parameters of each of the sub-neural networks is performed simultaneously during training. Implemented with multiple sub-neural networks, embedding space encoder 204 is trained using a similarity function that measures how different the encoded elements of one encoded embedding (vector) are from another.

In implementing a Siamese neural network, embedding space encoder 204 includes two models with shared weights working in tandem on two different inputs. In other arrangements, the individual samples of a triplet {x, x⁺, x⁻} are passed through the same one network serially, then the loss of the triplet is computed, and finally backpropagated through the one network to update the model's weights.

Embedding space encoder 204 passes the models' outputs on to a distance function, on top of which is computed the loss function described above. Embedding space encoder 204's Siamese neural network iteratively learns based on optimization of the distance function to identify comparable outputs, that is, encoded representations (vectors). Feature extraction for word embedding is performed by the backbone of embedding space encoder 204. The backbone encodes input to the embedding space encoder 204 into a specific, predetermined encoding representation. The backbone is an initial set of layers distinct among the complete set of layers of embedding space encoder 204, including the classification layer which computes the loss at training time and generates the prediction at inference time. The backbone can be any neural network. In certain embodiments, the backbone of embedding space encoder 204 is implemented as a context-sensitive, pre-trained transformer language model that generates different representations for words that share the same spelling but have different meanings (homonyms). For example, in some embodiments, the backbone of embedding space encoder 204 is the Bidirectional Encoder Representations from Transformers (BERT) machine learning language model. Accordingly, one embodiment of embedding space encoder 204 is a Siamese neural network having a BERT backbone.

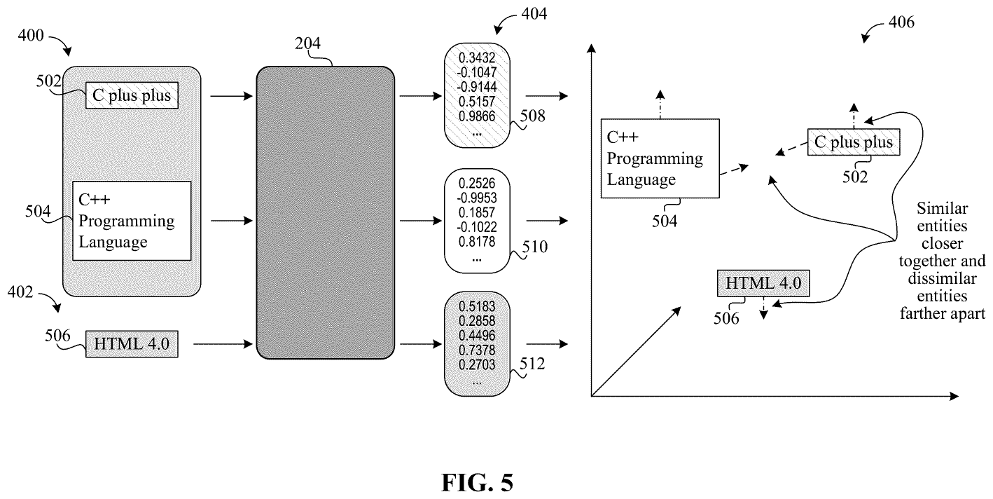

FIG. 5 schematically illustrates the training of embedding space encoder 204 using example similar entities 400 and example dissimilar entities 402. Similar entities 400 comprise entity 502 (C plus plus) and entity 504 (C+ programing language). Entity 506 (HTML 4.0) is dissimilar to both entities 502 and 504. Note that entities 502 and 504 are merely variants of the same application component, whereas entity 506 corresponds to different application component. Operatively, embedding space encoder 204 generates encoded representation 508 for entity 502, encoded representation 510 for entity 504, and encoded representation 512 for entity 506. Each encoded representation, illustratively, is a 5-tuple column vector that correspond to vectors within embedding space 406, a multi-dimensional vector space. In most applications, the vectors will be much larger than a 5-tuple. As encoded by embedding space encoder 204, entities 502 and 504 are similar and thus closer together within embedding space 406 relative to entity 506, which is dissimilar to both entities 502 and 504 and is farther apart from both.

Embedding space encoder 204, once trained through contrastive learning, is capable of encoding a set of standard entities S≡{s} and a set of mentions M≡{m} in the same multi-dimensional embedding space, such as embedding space 406. Entities (e.g., entities 212) are drawn from a knowledge base (e.g., knowledge base 214), while mentions (e.g., mention 208) are drawn from free-form text (e.g., free-form text 210). (See FIG. 2.) The vector-space properties of embedding space 406 are such that the similarity between encoded representations of entities drawn from a knowledge base and encoded representations of mentions extracted from a textual description of a technology stack can be quantified by standardizer 206 determining the vectorial distance between the encoded representations. In various embodiments, standardizer 206 determines similarity by computing the cosine distance between encoded representations of an entity and a mention. In other embodiments, standardizer 206 determines similarity by computing the Euclidean distance between encoded representations of an entity and a mention. In still other embodiments, standardizer 206 determines similarity between encoded representations of an entity and a mention by computing other vectorial distances.

The entities whose distance from each mention are computed by standardizer 206 can include names, noun phrases, abbreviations, acronyms, numbers, symbols, and the like drawn from a knowledge base of application components. Each of the entities contained in the knowledge base is predetermined to correspond to a name, noun phrase, abbreviation, acronym, number, symbol, or the like that is predetermined to be well-known and/or widely accepted as accurately identifying a specific application component. A mention extracted by extractor 202 from a textual description of a technology stack may be identical to a knowledge base entity. Accordingly, the extracted mention and the knowledge base entity are encoded by embedding space encoder 204 to have identical encoded representations, there is no distance between them. Mentions extracted by extractor 202 from a textual description of a technology stack may refer to known components and yet be described using unconventional terminology, atypical or unusual spellings or punctuations, or even misspellings. It is in these instances that the task of AES framework 200 is to map mention m∈M to an entity s∈S drawn from the knowledge base.

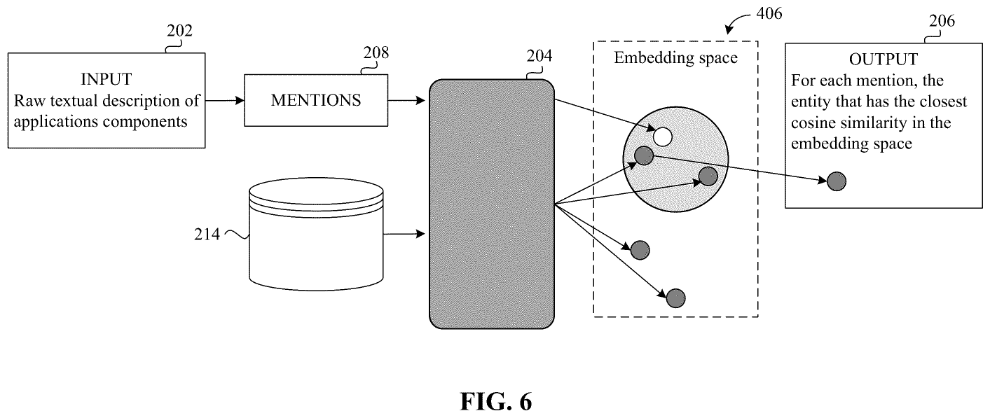

FIG. 6 schematically illustrates certain operative aspects of entity standardization performed by the AES framework 200. Illustratively, extractor 202 extracts mention(s) 208 from a text input of a technology stack describing various computer components of an application. Entities from knowledge base 214 along with mention(s) 208 are encoded by embedding space encoder 204. The encoded representations correspond to vectors in embedding space 406, a vector space. Each of mention(s) 208 is mapped to an entity by standardizer 206. The mapping standardizes each of mention(s) 208 by mapping each mention to a knowledge base entity. Thus, a mention that uses unconventional terminology, atypical or unusual spellings or punctuations, or even misspellings maps to an entity that is predetermined to be well-known and/or widely accepted as accurately identifying a specific application component.

The mapping is determined by standardizer 206 computing a vectorial distance (e.g., cosine similarity, Euclidean distance) as already described. Although a mention extracted from the technology stack description maps to the closest entity drawn from the knowledge base, in some embodiments an additional condition may imposed by standardizer 206. In these embodiments, the condition may be that the distance between encoded representations is no more than a predetermined maximum. Thus, if the distance between the encoded representation of the mention and that of the nearest entity is greater than the predetermined maximum, then standardizer 206 does not map the mention to any entity. This may be the case, for example, if the mention describes a novel application component for which there is no entity predetermined to be well-known and/or widely accepted as accurately identifying a specific application component.

Standardizer 206, in certain embodiments, automatically responds to the condition that the distances between the encoded representation of a mention and those of the entities drawn from knowledge base 214 are greater than the predetermined maximum. In some embodiments, standardizer 206 generates a user notification that no matching entity exists for the mention. Optionally, standardizer 206 can prompt the user to add a new entity to knowledge base 214 corresponding to the mention for which no matching entity was found.

FIG. 7 schematically illustrates an example standardization of mentions performed by the AES framework 200. Free-form text 210, input to extractor 202, includes the following description:

{
Version: 1.0.1,
Size: 34M,
Description: Db2 2.0, Tomcat 4.1, rhel 7.1,
...
}

from which extractor 202 extracts mentions 208, comprising:
Db2 2.0;
Tomcat 4.1; and
rhel 7.1.

Entities 212 drawn from knowledge base 214 illustratively include:
Db2;
Apache Tomcat;
c++;
Hypertext Markup Language (HTML);
Linux Red Hat Enterprise Linux; and
Android
. . .

Mentions 208 and entities 212 are encoded by embedding space encoder 204 as encoded representations (vectors) in embedding space 406.

Standardizer 206 maps each mentions 208 extracted from text 210 to an entity drawn from knowledge base 214. The mapping generates standardized mentions 218. Specifically, standardizer 206 maps mention Db2 2.0 to Db2, Tomcat 4.1 to Apache Tomcat, and rhel 7.1 to Linux Red Hat Enterprise Linux. Standardized mentions 218 thus illustratively comprise the entities:
Db2;
Apache Tomcat; and
Linux Red Hat Enterprise Linux.

Optionally, revised text 222 generated by text generator 220 replaces the mentions with entities. In revised text 222, mention Db2 2.0 is replaced by Db2. Mention Tomcat 4.1 is replaced by Apache Tomcat. Mention rhel 7.1 is replaced by Linux Red Hat Enterprise Linux.

In certain embodiments, in which embedding space encoder 204 is trained with a loss function that computes triplet losses (described above), embedding space encoder 204 is trained using a hybrid batch-all and batch-hard online triplet loss mining scheme. Online triplet mining generates triplets {x, x⁺, x⁻} on the fly within a batch. The batch-all training forms triplets from a batch of training samples that includes samples from more than one class, and each class contains at least two samples. If the size of the batch is B, then the number of all possible triplets is B³, but not all the triplets are valid—that is, not all triplets necessarily comprise two distinct samples from the same class and one sample from another class. Accordingly, only hard and semi-hard triplets (defined above) are used, and their average loss is computed. Soft triplets are excluded so as not to unduly reduce the average. During online triplet mining, computations are performed based on the embeddings of the batch after they pass through embedding space encoder 204. The other part of the hybrid scheme, batch-hard, selects the hardest positive sample and negative sample for each anchor in the batch. Each sample instance in a batch can be used as the anchor. Therefore, the number of triplets is always equal to the size of the batch. The hardest positive has the largest d(x, x+) among all positives and the hardest negative has the smallest d(x, x−) among all negatives.

During the training phase of embedding space encoder 204, the hybrid batch-all and batch-hard online triplet loss mining scheme can be adjusted across different epochs. Initially, for a few epochs, batch-all mining is utilized while batch-hard mining is unlikely to generate significantly different results. The unlikeliness stems from the fact that embedding space encoder 204, whose weights at the outset are randomly initialized, has yet to learn any meaningful representations within the embedding space. After a few epochs, however, with stronger embedding representations having been learned by embedding space encoder 204, batch-hard mining enables the model to converge faster to an optimal set of weights. In one example, half the total number of epochs are performed using batch-all mining and the other half are performed using batch-hard mining.

Once embedding space encoder 204 is trained, a user has multiple options for hashing the inputs to AES framework 200 at inference time when mentions are mapped to entities. One option is to hash only the entities in the knowledge base. The other option is to hash mentions extracted from text describing a technology stack, as well as the knowledge base entities. AES framework 200 optionally includes a hash generator (not shown) for hashing inputs to AES framework 200 at inference time. Certain experimental results suggest that hashing only entities drawn from knowledge database is more robust in terms of top-1 accuracy, which measures the proportion of mentions correctly mapped to an entity.

The terminology used herein is for the purpose of describing particular embodiments only and is not intended to be limiting. Notwithstanding, several definitions that apply throughout this document now will be presented.

The term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” means a human being.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
extracting, with a processor, a mention of a computer application component from a free-form text, wherein the free-form text is a textual description of a technology stack of the computer application;
encoding the mention with an embedding space encoder, wherein the encoding creates an encoded representation of the mention in a multi-dimensional embedding space, and wherein the embedding space encoder implements a machine learning model trained using contrastive learning;
mapping, with the processor, the encoded representation of the mention to an encoded representation of an entity in the multi-dimensional embedding space, wherein the entity is extracted from a knowledge base of computer components; and
outputting the entity whose encoded representation maps to the encoded representation of the mention.

2. The method of claim 1, wherein the machine learning model implemented by the embedding space encoder is a Siamese neural network.

3. The method of claim 1, wherein a backbone of the machine learning model implemented by the embedding space encoder is a context-sensitive, per-trained transformer language model.

4. The method of claim 1, wherein the embedding space encoder is trained using a hybrid batch-all and batch-hard online triplet loss mining.

5. The method of claim 1, wherein the mapping is performed by determining a vectorial distance between the encoded representation of the mention and the encoded representation of the entity in the knowledge base.

6. The method of claim 5, wherein the vectorial distance is determined based on a cosine similarity between the encoded representation of the mention and the encoded representation of the entity in the knowledge base.

7. The method of claim 1, further comprising:
mining a plurality of online databases for textual descriptions of computer application components;
compiling the textual descriptions in the knowledge base; and
encoding entities extracted from the textual descriptions in the multi-dimensional embedding space.

8. A system, comprising:
One or more processors configured to initiate operations including:
extracting a mention of a computer application component from a free-form text, wherein the free-form text is a textual description of a technology stack of the computer application;
encoding the mention with an embedding space encoder, wherein the encoding creates an encoded representation of the mention in a multi-dimensional embedding space, and wherein the embedding space encoder implements a machine learning model trained using contrastive learning;
mapping the encoded representation of the mention to an encoded representation of an entity in the multi-dimensional embedding space, wherein the entity is extracted from a knowledge base of computer components; and
outputting the entity whose encoded representation maps to the encoded representation of the mention.

9. The system of claim 8, wherein the machine learning model implemented by the embedding space encoder is a Siamese neural network.

10. The system of claim 8, wherein a backbone of the machine learning model implemented by the embedding space encoder is a context-sensitive, per-trained transformer language model.

11. The system of claim 8, wherein the embedding space encoder is trained using a hybrid batch-all and batch-hard online triplet loss mining.

12. The system of claim 8, wherein the mapping is performed by determining a vectorial distance between the encoded representation of the mention and the encoded representation of the entity in the knowledge base.

13. The system of claim 12, wherein the vectorial distance is determined based on a cosine similarity between the encoded representation of the mention and the encoded representation of the entity in the knowledge base.

14. A computer program product, the computer program product comprising:
one or more computer-readable storage media and program instructions collectively stored on the one or more computer-readable storage media, the program instructions executable by a processor to cause the processor to initiate operations including:
extracting a mention of a computer application component from a free-form text, wherein the free-form text is a textual description of a technology stack of the computer application;
encoding the mention with an embedding space encoder, wherein the encoding creates an encoded representation of the mention in a multi-dimensional embedding space, and wherein the embedding space encoder implements a machine learning model trained using contrastive learning;
mapping the encoded representation of the mention to an encoded representation of an entity in the multi-dimensional embedding space, wherein the entity is extracted from a knowledge base of computer components; and
outputting the entity whose encoded representation maps to the encoded representation of the mention.

15. The computer program product of claim 14, wherein the machine learning model implemented by the embedding space encoder is a Siamese neural network.

16. The computer program product of claim 14, wherein a backbone of the machine learning model implemented by the embedding space encoder is a context-sensitive, per-trained transformer language model.

17. The computer program product of claim 14, wherein the embedding space encoder is trained using a hybrid batch-all and batch-hard online triplet loss mining.

18. The computer program product of claim 14, wherein the mapping is performed by determining a vectorial distance between the encoded representation of the mention and the encoded representation of the entity in the knowledge base.

19. The computer program product of claim 18, wherein the vectorial distance is determined based on a cosine similarity between the encoded representation of the mention and the encoded representation of the entity in the knowledge base.

20. The computer program product of claim 14, wherein the program instructions are executable by the processor to cause the processor to initiate operations further including:
mining a plurality of online databases for textual descriptions of computer application components;
compiling the textual descriptions in the knowledge base; and
encoding entities extracted from the textual descriptions in the multi-dimensional embedding space.

21. A method, comprising:
generating, with a processor, a stand-alone encoder, wherein the stand-alone encoder implements a contrastive learning model trained using a hybrid batch-all and batch-hard online triplet mining; and
encoding, by the stand-alone encoder, a plurality of entities drawn from a knowledge base, wherein the encoding creates a unique encoded representation of each of the plurality of entities.

22. The method of claim 21, wherein the machine learning model implemented by the stand-alone encoder is a Siamese neural network.

23. The method of claim 21, wherein a backbone of the machine learning model is a context-sensitive, per-trained transformer language model.

24. The method of claim 21, further comprising:
encoding, with the stand-alone encoder, an entity added to existing entities of the knowledge base;
wherein no further training of the stand-alone encoder is necessary in response to the encoding the entity added to the exiting entities of the knowledge base.

25. A method, comprising:
generating, with a processor, a plurality of triplet examples to train a contrastive learning model;
iteratively adjusting, by the processor, parameters of the contrastive learning model during an initial sequence of training epochs using batch-all mining with the triplet examples; and
further adjusting, by the processor, parameters of the contrastive learning model during a subsequent sequence of training epochs using batch-hard mining as the parameters converge to a final set of values.
